(19) United States
(12) Patent Application Publication
(10) Pub. No.: US 2013/0059754 A1
(43) Pub. Date: Mar. 7, 2013

(54) DIGITAL ASSAYS WITH REDUCED MEASUREMENT UNCERTAINTY

(71) Applicant: Svilen Tzonev, Pleasanton, CA (US)

(72) Inventor: Svilen Tzonev, Pleasanton, CA (US)

(73) Assignee: BIO-RAD LABORATORIES, INC., Hercules, CA (US)

(21) Appl. No.: 13/603,235

(22) Filed: Sep. 4, 2012

Related U.S. Application Data
(60) Provisional application No. 61/530,340, filed on Sep. 1, 2011.

(51) Int. Cl. C40B 30/04

(52) U.S. Cl. 506/9

(57) ABSTRACT

The present disclosure provides a digital assay system, includes methods and apparatus, with reduced measurement uncertainty. In an exemplary method, an expected value for a measure that is a function of a level of a first target and a level of a second target in a sample may be provided. An optimal concentration for the first target may be obtained based on the expected value. An experimental value for the measure may be determined from a digital assay with partitions formed according to the optimal concentration.

### CROSS-REFERENCE TO PRIORITY APPLICATION

This application is based upon and claims the benefit under 35 U.S.C. §119(e) of U.S. Provisional Patent Application Ser. No. 61/530,340, filed Sep. 1, 2011, which is incorporated herein by reference in its entirety for all purposes.

### CROSS-REFERENCES TO OTHER MATERIALS

This application incorporates by reference in their entireties for all purposes the following materials: U.S. Pat. No. 7,041,481, issued May 9, 2006; U.S. Patent Application Publication No. 2010/0173394 A1, published Jul. 8, 2010; U.S. Patent Application Publication No. 2011/0217712 A1, published Sep. 8, 2011; U.S. Patent Application Publication No. 2012/0152369 A1, published Jun. 21, 2012; U.S. patent application Ser. No. 13/251,016, filed Sep. 30, 2011; U.S. patent application Ser. No. 13/424,304, filed Mar. 19, 2012; U.S. patent application Ser. No. 13/548,062, filed Jul. 12, 2012; and Joseph R. Lakowicz, PRINCIPLES OF FLUORESCENCE SPECTROSCOPY (2^{nd} Ed. 1999).

### INTRODUCTION

Digital assays generally rely on the ability to detect the presence or activity of individual copies of an analyte in a sample. In an exemplary digital assay, a sample is separated into a set of partitions, generally of equal volume, with each containing, on average, about one copy of the analyte. If the copies of the analyte are distributed randomly among the partitions, some partitions should contain no copies, others only one copy, and, if enough partitions are formed, still others should contain two copies, three copies, and even higher numbers of copies. The probability of finding exactly 0, 1, 2, 3, or more copies in a partition, based on a given average concentration of analyte in the partitions, is described by a Poisson distribution. Conversely, using Poisson statistics, the concentration of analyte in the partitions (and thus in the sample) may be estimated from the probability of finding a given number of copies in a partition.

Estimates of the probability of finding no copies and of finding one or more copies may be measured in the digital assay. Each partition can be tested to determine whether the partition is a positive partition that contains at least one copy of the analyte, or is a negative partition that contains no copies of the analyte. The probability of finding no copies in a partition can be approximated by the fraction of partitions tested that are negative (the “negative fraction”), and the probability of finding at least one copy by the fraction of partitions tested that are positive (the “positive fraction”). The negative fraction, or, equivalently, the positive fraction then may be utilized in a Poisson equation to determine the concentration of the analyte in the partitions.

Digital assays frequently involve a nucleic acid target as the analyte. The target can be amplified in partitions to enable detection of a single copy of the target. Amplification may, for example, be conducted via the polymerase chain reaction (PCR) to achieve a digital PCR assay. Amplification of the target can be detected optically from a photoluminescent reporter included in the reaction. The reporter can include a dye that provides a signal indicating whether or not the target has been amplified in any given partition.

In a digital assay of the type described above, it is expected that there will be data available for each of a relatively large number of sample-containing partitions, such as droplets. For example, assay data can be collected from hundreds, thousands, tens of thousands, hundreds of thousands of droplets, or more. However, it is desirable to design the digital assays so that they provide the most accurate information for the number of partitions analyzed. In this way, target data of higher quality can be obtained through analysis of fewer partitions, allowing smaller samples and a greater number of samples to be analyzed.

### SUMMARY

The present disclosure provides a digital assay system, includes methods and apparatus, with reduced measurement uncertainty. In an exemplary method, an expected value for a measure that is a function of a level of a first target and a level of a second target in a sample may be provided. An optimal concentration for the first target may be obtained based on the expected value. An experimental value for the measure may be determined from a digital assay with partitions formed according to the optimal concentration.

### BRIEF DESCRIPTION OF THE DRAWINGS

FIG. 1 is a flowchart of steps for an exemplary method of performing a digital assay with reduced measurement uncertainty, in accordance with aspects of the present disclosure.

FIG. 2 is a schematic representation of an exemplary system for performing the digital assay of FIG. 1, in accordance with aspects of the present disclosure.

FIG. 3 is a flow diagram illustrating generation of a graph plotting relative uncertainty of measured target concentration as a function of target concentration expressed as copies per partition, in accordance with aspects of the present disclosure.

FIG. 4 is a portion of the graph of FIG. 3 marked with dashed lines to identify optimal concentrations for digital assay of a pair of targets having various copy number ratios, in accordance with aspects of the present disclosure.

FIG. 5 is a graph plotting the optimal target concentrations of FIG. 4 as a function of copy number ratio, in accordance with aspects of the present disclosure.

FIG. 6 is a graph of the probability distributions for a sequential pair of copy number ratios that are integers, with the 95% confidence interval for each distribution shown with respect to the mean of the distribution, in accordance with aspects of the present disclosure.

FIG. 7 is a graph of 95% confidence intervals (one-sided and two-sided) as a function of copy number ratio, in accordance with aspects of the present disclosure.

### DETAILED DESCRIPTION

The present disclosure provides a digital assay system, includes methods and apparatus, with reduced measurement uncertainty. In an exemplary method, an expected value for a measure that is a function of a level of a first target and a level of a second target in a sample may be provided. An optimal concentration for the first target may be obtained based on the expected value. An experimental value for the measure may be determined from a digital assay with partitions formed according to the optimal concentration.

The system uses appropriate sampling statistics, such as Poisson sampling statistics, to predict the uncertainty in measurement of target levels. This, in turn, allows the determination of a preferred concentration for reducing errors when measuring concentrations and/or derivative measures in partitioned samples. For example, the system predicts that concentrations of a single target can best (most quickly and reliably) be measured at concentrations of about 1.6 copies per sample partition. The system further predicts that derivative measures based on concentration of a pair of targets, such as copy number variation (CNV), target linkage, or relative abundance of a mutant target, among others, can best be measured at optimal target concentrations calculable, analytically and/or numerically, based on details of how the derivative measures depend on target concentration. The system makes it possible to set preferred operating conditions for a variety of assays and to determine the minimum numbers of sample partitions required to achieve particular performance levels.

An exemplary method of performing a digital assay with reduced measurement uncertainty is provided. In the method, an expected value may be provided for a measure that is a function of a level of a first target and a level of a second target in a sample. An optimal concentration for the first target may be obtained based on the expected value. Partitions may be formed based on the optimal concentration obtained. Each partition may include a portion of the sample. Only of subset of the partitions may contain at least one copy of the first target, and only a subset of the partitions may contain at least one copy of the second target. The first and second targets may be amplified in the partitions. Amplification data may be collected from the partitions. An experimental value for the measure may be determined based on the amplification data.

Another exemplary method of performing a digital assay with reduced measurement uncertainty is provided. In the method, an expected value may be provided for a ratio involving a level of a first target and a level of a second target in a sample. A preferred concentration may be selected for the first target based on the expected value and a table containing a set of potential values or ranges for the ratio. Each potential value or range may be associated in the table with an optimal target concentration for such potential value or range. Droplets may be formed according to the desired concentration. Each droplet may include a portion of the sample. Only a subset of the droplets may contain at least one copy of the first target, and only a subset of the droplets may contain at least one copy of the second target. The first and second targets may be amplified in the droplets. Amplification data may be collected from the droplets. An experimental value may be determined for the ratio based on the amplification data.

Further aspects of the present disclosure are described in the following sections: (I) system overview, (II) relative uncertainty of concentration measurements, (III) assay conditions for a pair of targets, and (IV) selected embodiments.

### I. System Overview

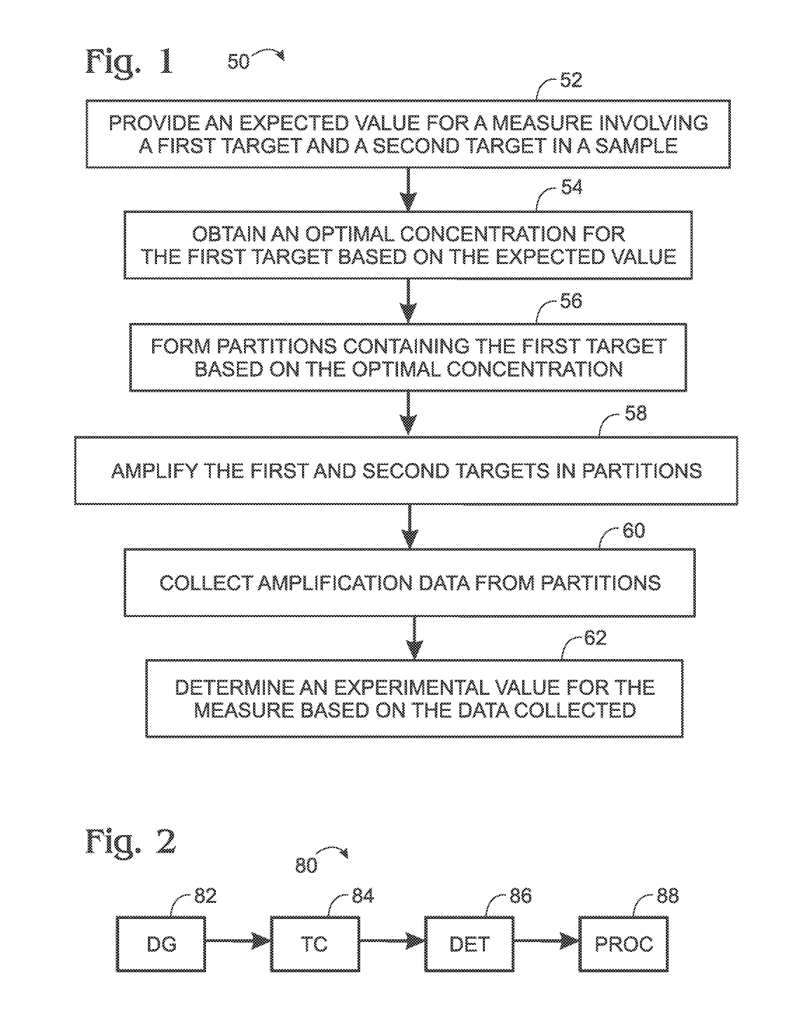

This section describes an overview of an exemplary digital assay system with reduced measurement uncertainty; see FIGS. 1 and 2.

FIG. 1 shows a flowchart of an exemplary method 50 of performing a digital assay with reduced measurement uncertainty. The steps presented for method 50 may be performed in any suitable order and in any suitable combination. Furthermore, the steps may be combined with and/or modified by any other suitable steps, aspects, and/or features of the present disclosure.

Expected Values and Measures.

An expected value for a measure involving first and second targets in a sample may be provided, indicated at 52.

The expected value is generally an estimate or best guess for the value of the measure. Accordingly, the expected value may be obtained from a test of one or more other samples, a preliminary test of the sample to determine an approximate value for the measure, a reported value and/or accepted value of the measure for a larger population (for which the sample or its source is a member), a value for an analogous measure with other targets, or the like.

The measure may be any suitable function of a level of a first target and a level of a second target (and, optionally, levels or one or more other targets). The first and second target levels may be different from one another or may be equal to each other. The level of each target may be a relative level (e.g., relative to another target(s)), or an absolute level, such as concentration (e.g., copies of the target per partition). The measure may be a ratio involving the level and/or concentration of each target.

The ratio may be the level of the first target divided by the level of the second target, or the level of the second target divided by the level of the first target. Such a target ratio may represent a copy number ratio for the targets, which may be used to characterize copy number variation for one of the targets, such as the second target. The first target may correspond to a reference template having a known copy number (e.g., one copy per haploid genome or two copies per diploid genome), and the second target may correspond to a test template having a copy number to be determined relative to the reference template. A ratio of first and second target levels may represent a ratio of mutant to wild-type target, or vice versa.

In other cases, the ratio may be the level of the first target divided by a sum of levels of the first and second targets, or the sum divided by the level of the first or second target. For example, the first target may represent a mutation(s) in a gene and the second target may represent a wild-type version of the gene. The ratio thus may represent a ratio of mutant or variant target(s) to total target (mutant plus wild-type), or vice versa.

In still other cases, the ratio may correspond to a level of linkage or non-linkage of the first and second targets to each other. The level of linkage may be determined based on the total number of partitions, and the observed numbers of partitions that are positive for only the first target, positive for only the second target, and double positive (i.e., positive for both targets). The excess, if any, of double-positive partitions above the number expected by chance, as predicted by the numbers of single-positive partitions, allows calculation of the level of linkage. At one extreme, if each partition positive for the first target is also positive for the second target, and vice versa, then the targets are 100% linked. At the other extreme, if there is no excess of double-positive partitions over the number expected by chance co-localization of unlinked targets in the same partitions, then the targets are 0% linked. At an intermediate level of linkage between these two extremes, numerical or analytical approaches may be utilized to determine the level of linkage that accounts for the observed numbers of single- and double-positive partitions. Further aspects of determining a level of linkage in a digital assay, with linkage being the inverse of fragmentation, are described in the references listed above under Cross-References, which are incorporated herein by reference, particularly U.S. patent application Ser. No. 13/424,304, filed Mar. 19, 2012.

Obtaining an Optimal Concentration.

An optimal concentration for the first target may be obtained, indicated at 54, based on the expected value provided for the measure (at 52). The optimal concentration interchangeably may be termed a preferred concentration.

The optimal concentration may be a single concentration value or a range of concentration values. The optimal concentration is a preferred assay condition for the first target, for determination of the measure by digital assay, and minimizes a predicted measurement uncertainty (e.g., the relative uncertainty, see Section II) due to sampling errors.

The optimal concentration may be obtained by consulting a table containing a set of pre-computed optimal concentrations each associated with a different potential value or potential range for the measure. Each pre-computed concentration may be a single concentration value or a range of concentration values. To obtain the optimal concentration based on the expected value, the expected value may be compared with the potential values or ranges in the table, to select one of the potential values or ranges that most closely corresponds to the expected value. The pre-computed concentration associated with the selected value or range then may be selected as the optimal target concentration for the assay. In some cases, the table may contain, for the potential values, any combination of integers (e.g., 1, 2, 3, etc.), half-integers (e.g., any of 0.5, 1.5, 2.5, 3.5, etc.), and/or fractions (e.g., ¼, ⅓, ½, etc.).

The table may be provided in any suitable form. The table may be stored in digital form and may be provided by an electronic device (e.g., a computer). Alternatively, the table may be provided by a printed document, among others.

In other examples, the optimal concentration may be computed “on the fly” after the expected value has been provided. Calculation of the optimal concentration may be performed by the user, a computing device (e.g., a computer or calculator), or a combination thereof, among others.

Sample Preparation.

A sample may be prepared for forming, and/or addition to, partitions. Preparation of the sample may include any suitable manipulation of the sample, such as collection, dilution, concentration, purification, lyophilization, freezing, extraction, combination with one or more assay reagents, performance of at least one preliminary reaction (e.g., fragmentation, reverse transcription, ligation, or the like) to prepare the sample for one or more reactions in the assay, or any combination thereof, among others. Preparation of the sample may include rendering the sample competent for subsequent performance of one or more reactions, such as one or more enzyme-catalyzed reactions and/or one or more binding reactions, for example, amplification of one or more types of target (e.g., a first target and a second target) in partitions containing portions of the sample. (A target interchangeably may be termed a template, and an amplified target or amplified template interchangeably may be termed an amplicon.)

In some embodiments, preparation of the sample may include combining the sample with reagents for amplification and for reporting whether or not amplification occurred. Reagents for amplification may include any combination of primers for the targets (e.g., a distinct pair of primers for each target), dNTPs and/or NTPs, at least one enzyme (e.g., a polymerase, a ligase, a reverse transcriptase, or a combination thereof, each of which may or may not be heat-stable), and/or the like. Accordingly, preparation of the sample may render the sample (or partitions thereof) capable of amplification of each target, if a copy of the target is present, in the sample (or a partition thereof). Reagents for reporting may include a distinct reporter for each target, or the same reporter (e.g., an intercalating dye) for at least two targets. Accordingly, preparation of the sample for reporting may render the sample capable of reporting, or being analyzed for, whether or not amplification has occurred for each target in each individual partition. The reporter may interact at least generally nonspecifically or specifically with each template (and/or amplicon generated therefrom). In some cases, the reporter may have a general affinity for nucleic acid (single and/or double-stranded) without substantial sequence specific binding. In some cases, the reporter may be a labeled probe that includes a nucleic acid (e.g., an oligonucleotide) labeled with a luminophore, such as a fluorophore or phosphor, among others. The probe may be configured to bind to an amplified target (e.g., binding specifically to the original template, to amplicons generated from the template, or both).

The system may be used to design, perform, and/or analyze digital assays, in any suitable manner. For example, for a given assay, the equations of the present disclosure or their analogs may be used to determine preferred assay conditions. Sample(s) may then be prepared accordingly, for example, by diluting or concentrating the samples so that target concentrations are at or near operating points or operating ranges.

Partition Formation.

Partitions may be formed based on the optimal concentration, indicated at 56. For example, the partitions may be formed with the first target, the second target, or each target present in the partitions according to the optimal concentration. Each partition may contain a portion of the sample. The sample portion may or may not contain a copy of the first target and/or a copy of the second target, since target copies are distributed randomly among the partitions. Generally, to perform a digital assay, the target copies are distributed such that only a subset (i.e., less than all) of the partitions contain at least one copy of the first target, and only a subset (i.e., less than all) of the partitions contain at least one copy of the second target.

The sample may be divided or separated into the partitions. Each partition may be and/or include a fluid volume (and/or a particle) that is isolated from the fluid volumes (and/or particles) of other partitions. The partitions may be isolated from one another by a fluid phase, such as a continuous phase of an emulsion, by a solid phase, such as at least one wall of a container, or a combination thereof, among others. In some embodiments, the partitions may be droplets disposed in a continuous phase, such that the droplets and the continuous phase collectively form an emulsion.

In some embodiments, the sample may contain particles (e.g., beads), which may, for example, be paramagnetic and/or composed of a polymer (e.g., polystyrene). The particles may be pre-attached to any suitable component(s), such as one or more types of primer, template(s), or the like, before sample partitioning. The particles may be disposed in the partitions when the sample is distributed to partitions, optionally with an average of about one particle (or less) per partition.

The partitions may be formed by any suitable procedure, in any suitable manner, and with any suitable properties. For example, the partitions may be formed with a fluid dispenser, such as a pipette, with a droplet generator, by agitation of the sample (e.g., shaking, stirring, sonication, etc.), and/or the like. Accordingly, the partitions may be formed serially, in parallel, or in batch. The partitions may have any suitable volume or volumes. The partitions may be of substantially uniform volume or may have different volumes. Exemplary partitions having substantially the same volume are monodisperse droplets. Exemplary volumes for the partitions include an average volume of less than about 100, 10 or 1 μL, less than about 100, 10, or 1 mL, or less than about 100, 10, or 1 pL, among others. Formation of the partitions may include modifying partitions (such as droplets) by adding one or more reagents and/or additional fluid to the partitions. The reagents and/or fluid may be added by any suitable mechanism, such as a fluid dispenser, fusion of droplets, or the like.

The partitions may be formed to have any suitable target concentration. In some cases, the partitions may contain an average per partition of less than about ten copies of one or more types of target when target amplification is initiated. For example, the partitions may contain an average per partition of less than about five, three, or two copies of one or more types of target when target amplification is initiated. In some cases, the partitions may contain an average of less than one copy per partition of at least one type of target when target amplification is initiated.

Target Amplification.

First and second targets may be amplified in partitions, indicated at 58. Amplification of each target may occur selectively (and/or substantially) in only a subset of the partitions, such as less than about nine-tenths, three-fourths, one-half, one-fourth, or one-tenth of the partitions, among others. In some examples, the amplification reaction may be a polymerase chain reaction and/or ligase chain reaction. Accordingly, a plurality of amplification reactions for a plurality of targets may be performed simultaneously in the partitions.

Amplification may or may not be performed isothermally. In some cases, amplification in the partitions may be encouraged by heating the partitions and/or incubating the partitions at a temperature above room temperature, such as at a denaturation temperature, an annealing temperature, and/or an extension temperature. In some examples, the partitions may be cycled thermally to promote a polymerase chain reaction and/or ligase chain reaction. Exemplary isothermal amplification approaches that may be suitable include nucleic acid sequence-based amplification, transcription-mediated amplification, multiple displacement amplification, strand displacement amplification, rolling circle amplification, loop-mediated amplification of DNA, helicase-dependent amplification, or single primer amplification, among others.

Data Collection.

Amplification data may be collected from partitions, indicated at 60. Data collection may include detecting light emitted from partitions. One or more signals representative of light detected from the partitions may be created. The signal may represent an aspect of light, such as the intensity, polarization, resonance energy transfer, and/or lifetime of light emitted from the partitions. Light emission may be photoluminescence (e.g., fluorescence) of a luminophore (e.g., a fluorophore) in response to illumination of the partitions with excitation light.

Amplification data may be collected at any suitable time(s). Exemplary times include at the end of an assay (endpoint assay), when reactions have run to completion and the data no longer are changing, or at some earlier time, as long as the data are sufficiently and reliably separated.

Experimental Value Determination.

An experimental value may be determined for the measure based on the data collected, indicated at 62. The experimental value is an actual measured value from the digital assay and corresponds at least generally to the expected value provided. The experimental value may be a more accurate and/or reliable revision of the expected value, or may be a confirmation of the expected value (e.g., if the expected value is an integer or fraction). In some cases, if the experimental value differs sufficiently from the expected value used to predict the preferred conditions under which the assay was performed, a new set of preferred conditions can be determined based on the experimental value (as the expected value) and the assay re-run under those new conditions.

In any event, to determine an experimental value, amplification of each type of target in individual partitions may be distinguished based on the collected data. A number of partitions that are positive (and/or negative) for each target alone or both targets may be determined based on the data. The signal detected from each partition, and the partition itself, may be classified as being positive or negative for each of the target types. Classification may be based on the strength (and/or other suitable aspect) of the signal. If the signal/partition is classified as positive (+), for a given target, amplification of the target is deemed to have occurred and at least one copy of the target is deemed to have been present in the partition before amplification. In contrast, if the signal/partition is classified as negative (−), for a given target, amplification of the target is deemed not to have occurred and no copy of the target is deemed to be present in the partition (i.e., the target is deemed to be absent from the partition).

The level of each target may be determined based on the number of partitions that are amplification-positive (or negative) for the target. The calculation may be based on each target having a Poisson distribution among the partitions. The measure may be a relative level of a target, such as a ratio of the level of one template type to another template type (e.g., a ratio of mutant to wild-type template). The total number of partitions may be counted or, in some cases, estimated. The partition data further may be used (e.g., directly and/or as concentration data) to estimate copy number (CN) and copy number variation (CNV).

Concentrations and associated uncertainties may be determined using any suitable methods. These may include measuring the fluorescence of each sample-containing droplet, determining the target molecule concentration in each droplet based on the measured fluorescence, and then extracting means, variances, and/or other aspects of the concentration under the assumption that the target molecule concentration follows a particular distribution function such as a Poisson distribution function. Exemplary techniques to estimate the mean and variance of target molecule concentration in a plurality of sample-containing droplets are described, for example, in the following patent documents, which are incorporated herein by reference: U.S. Provisional Patent Application Ser. No. 61/277,216, filed Sep. 21, 2009; and U.S. Patent Application Publication No. 2010/0173394 A1, published Jul. 8, 2010.

An absolute level (e.g., a concentration) of one or more targets may be determined. A fraction of the total number of partitions that are negative (or, equivalently, positive) for a target may be calculated. The fraction may be calculated as the number of counted negative (or, equivalently, positive) partitions for the target divided by the total number of partitions.

The concentration of the target may be obtained. The concentration may be expressed with respect to the partitions and/or with respect to a sample disposed in the partitions and serving as the source of the target. The concentration of the target in the partitions may be calculated from the fraction of positive partitions by assuming that template copies have a Poisson distribution among the partitions. With this assumption, the fraction f(k) of partitions having k copies of the target is given by Equation (1):

$$f ( k ) = ( \frac{{c}^{k}}{k !} ) {e}^{- c} \qquad ( 1 )$$

Here, c is the concentration of the target in the partitions, expressed as the average number of template copies per partition. Simplified Poisson equations may be derived from the more general equation above and used to determine template concentration from the fraction of positive partitions. An exemplary Poisson equation that may be used is as follows:

c=−ln(1−p₊) (2)

where p₊ is the fraction of partitions positive for the template type (i.e., p₊=f(1)+f(2)+f(3)+ . . . ), which is a measured estimate of the probability of a partition having at least one copy of the template type. Another exemplary Poisson equation that may be used is as follows:

c=−ln(p₀) (3)

where pₒ is the fraction of negative droplets (or 1−p₊), which is a measured estimate of the probability of a droplet having no copies of the template type, and c is the concentration as described above.

In some embodiments, an estimate of the concentration of the template type may be obtained directly from the positive fraction, without use of a Poisson equation. In particular, the positive fraction and the concentration converge as the concentration decreases. For example, with a positive fraction of 0.1, the concentration is determined with the above equation to be about 0.105, a difference of only 5%; with a positive fraction of 0.01, the concentration is determined to be about 0.01005, a ten-fold smaller difference of only 0.5%. However, use of a Poisson equation can provide a more accurate estimate of concentration, particularly with a relatively higher positive fraction, because the equation accounts for the occurrence of multiple copies of a given target per partition.

Further aspects of sample preparation, measures involving a pair of targets, partition formation, target amplification, data collection, and target level determination, among others, that may be suitable for the system of the present disclosure are described in the references listed above in the Cross-References, which are incorporated herein by reference.

FIG. 2 shows an exemplary system 80 for performing any suitable combination of steps of the digital assay of FIG. 1. System 80 may include a partitioning assembly, such as a droplet generator 82 (“DG”), a thermal incubation assembly, such as a thermocycler 84 (“TC”), a detection assembly (a detector) 86 (“DET”), and a data processing assembly (a processor) 88 (“PROC”), or any combination thereof, among others. The data processing assembly may be, or may be included in, a controller that communicates with and controls operation of any suitable combination of the assemblies. The arrows between the assemblies indicate movement or transfer of material, such as fluid (e.g., a continuous phase of an emulsion) and/or partitions (e.g., droplets) or signals/data, between the assemblies. Any suitable combination of the assemblies may be operatively connected to one another, and/or one or more of the assemblies may be unconnected to the other assemblies, such that, for example, material/data is transferred manually.

Apparatus 80 may operate as follows. Droplet generator 82 may form droplets disposed in a continuous phase. The droplets may be cycled thermally with thermocycler 84 to promote amplification of targets in the droplets. Signals may be detected from the droplets with detector 86. The signals may be processed by processor 88 to determine numbers of droplets, target levels, and/or experimental values, among others.

### II. Relative Uncertainty of Concentration Measurements

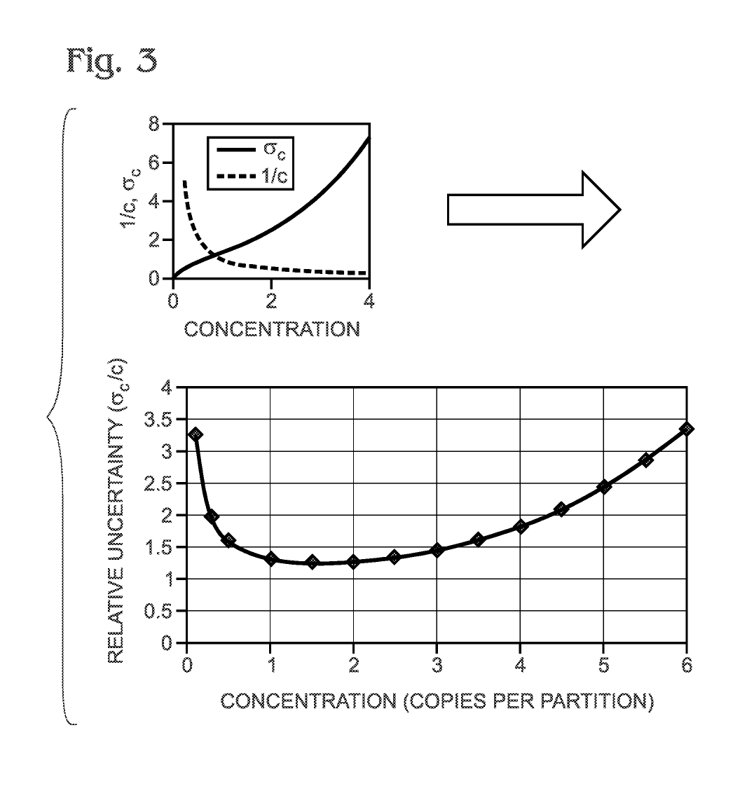

This section describes relationships between concentration measurements and relative uncertainty of such measurements in digital assays; see FIG. 3.

FIG. 3 shows a flow diagram illustrating generation of a graph for the relative uncertainty of measured target concentration, δ_{c} (or coefficient of variation, CV_{c}), as a function of target concentration, c (copies per partition). The top left of the figure shows a plot of the components of the fundamental relative uncertainty, namely, reciprocal target concentration (dashed line) and sampling uncertainty (or standard deviation), σ_{c} (solid line), which are multiplied by one another to produce a curve for the relative uncertainty as a function of concentration, with N=1. The actual error can be derived from the fundamental uncertainty by multiplying by 1/\sqrt{N}, where N is the number of sample partitions.

The system may be used to facilitate the measurement of concentrations and derivative measures in digital assays. The relative uncertainty of concentration, δ_{c}, in such measurements—defined as the ratio of sampling uncertainty, σ_{c}, to concentration, c—may be described for a Poisson system in terms of the total number of observations (i.e., the number of sample partitions (e.g., droplets) analyzed), N, and the concentration, c, of target in those partitions as follows:

$${δ}_{c} = {CV}_{c} = \frac{{σ}_{c}}{c} = \frac{1}{\sqrt{N}} \frac{\sqrt{{e}^{c} - 1}}{c} \qquad ( 4 )$$

Equation (4) shows that the relative uncertainty in a concentration measurement may be reduced by decreasing either or both of the quantities 1/\sqrt{N} and \sqrt{e^{c}−1}/c. These quantities, in turn, may be reduced by increasing the total number of observations (or sample partitions), N, and/or by conducting the assay at a concentration or operating point cₘᵢₙ that reduces or minimizes \sqrt{e^{c}−1}/c, respectively.

The latter quantity, cₘᵢₙ, turns out to be about 1.59 (or 1.6) copies per sample partition (i.e., the minimum of the relative uncertainty curve in FIG. 3). More generally, to yield significantly improved assay results, the latter quantity may be in a range about this minimum, for example, from about 1.55 to 1.65, 1.25 to 1.75, 1 to 2, 0.8 to 2.8, 0.6 to 3.0, 0.3 to 4.6, or 0.225 to 2.25, among others. The preferred operating ranges for c are not symmetric around the preferred operating point 1.6 for c because the quantity \sqrt{e^{c}1}/c is not symmetric about 1.6. The relative uncertainty, δ_{c,min}, for c=1.593 can be obtained by evaluating Equation (4) for c=1.593, yielding δ_{c,min}=1.243/\sqrt{N}. The 95% confidence interval can be generated from δ_{c,min} as 2*1.96*δ_{c,min}, assuming a Gaussian distribution of errors around the mean (which is asymptotically correct for large N).

### III. Assay Conditions for a Pair of Targets

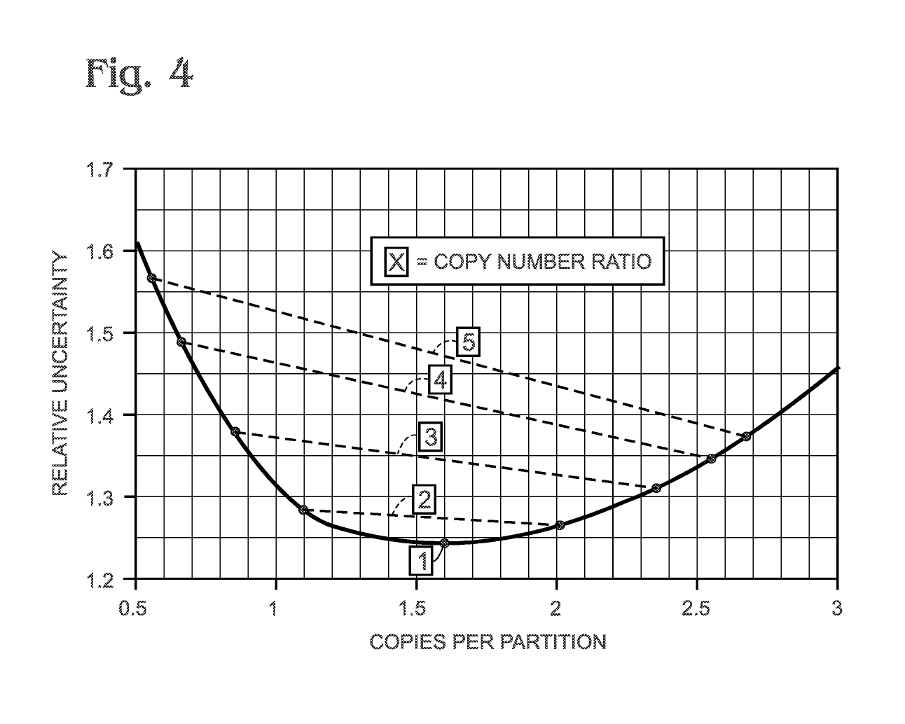

This section describes an exemplary approach for determining optimal target concentrations for digital assay of a pair of targets; see FIGS. 4-7.

The system may be used to facilitate the measurement of derivative measures, F(c), based on concentration:

$$\begin{matrix}F = F ( c ) & ( 5 ) \\ {σ}_{F} = \vert \frac{d F}{d c} \vert {σ}_{c} & ( 6 ) \\ {δ}_{F} = \frac{{σ}_{F}}{F} = \frac{1}{F} \vert \frac{d F}{d c} \vert {σ}_{c} = \frac{1}{F} \vert \frac{d F}{d c} \vert c {δ}_{c} & ( 7 )\end{matrix}$$

Equation (7) shows that the relative uncertainty, δ_{F} (or CV_{F}), in a derivative measure may be expressed in terms of the total number of sample observations (through the dependence of δ_{F} on N) and the sample concentration. This equation may be used to determine preferred operating points and operating ranges for a given derivative measure F by determining values of N and c that reduce or minimize δ_{F}.

One example of a derivative measure is Copy Number Variation (CNV). The CNV, also termed a copy number ratio, α, is given by Equation (8):

α=cₜ/cᵣ (8)

where cₜ and cᵣ are test and reference concentrations for respective test and reference targets, respectively.

$$\begin{matrix}ln ( α ) = ln ( {c}_{t} ) - ln ( {c}_{r} ) & ( 9 ) \\ {σ}_{ln ( α )}^{2} = {σ}_{ln ( {c}_{t} )}^{2} + {σ}_{ln ( {c}_{r} )}^{2} & ( 10 ) \\ {σ}_{ln ( x )} = \vert \frac{d ln ( x )}{d x} \vert {σ}_{x} = \frac{1}{x} {σ}_{x} = {δ}_{x} & ( 11 ) \\ {δ}_{α}^{2} = {δ}_{{c}_{t}}^{2} + {δ}_{{c}_{r}}^{2} & ( 12 )\end{matrix}$$

Equation (10) assumes that the test and reference concentration uncertainties are not correlated. Equations (10) to (12) collectively show that the measurement uncertainty of the copy number ratio is given by the sum of the squared concentration uncertainties of the test target and reference target.

$${δ}_{α}^{2} \sim \frac{{e}^{{c}_{t - 1}}}{{c}_{t}^{2}} + \frac{{e}^{{c}_{r - 1}}}{{c}_{r}^{2}} = \frac{{e}^{α {c}_{r} - 1}}{{α}^{2} {c}_{r}^{2}} + \frac{{e}^{{c}_{r - 1}}}{{c}_{r}^{2}} \qquad ( 13 )$$

Given an expected value for α, Equation (13) can be utilized to compute an optimal concentration of the reference target that minimizes the relative error of the CNV measurement, assuming cₜα=α_{expected}cᵣ. Equation (13) can be solved numerically to compute a table of cᵣ and cₜ values as a function of the expected value of α. These concentrations may be expressed for a Poisson system as listed in Table 1.

TABLE 1

| α (cₜ/cᵣ) | 1 | 2 | 3 | 4 | 5 | 6 | 7 |
|---|---|---|---|---|---|---|---|
| cₜ | 1.594 | 2.104 | 2.372 | 2.561 | 2.710 | 2.834 | 2.942 |
| cᵣ | 1.594 | 1.052 | 0.791 | 0.640 | 0.542 | 0.472 | 0.420 |

Here, when the ratio of test gene to reference gene is about 1, the preferred assay concentrations of both genes are about 1.59 copies per sample partition. However, as the ratio of test gene to reference gene rises, the preferred concentrations of test and reference genes change, both absolutely and relative to one another. For example, if the ratio is about two, the preferred concentrations of test and reference genes are about 2.10 and 1.05, respectively, if the ratio is about three, the preferred concentrations are about 2.37 and 0.79, respectively, and so on. Also, if the expected value of the ratio is the reciprocal of that shown in the table, the preferred concentrations of test and reference genes are switched. For example, if the expected value is about 0.5 (the reciprocal of 2), the preferred concentrations of test and reference genes are about 1.05 and 2.10, respectively. Note that an expected value of one gives the same optimal concentration, 1.59, as for a single concentration measurement (see Section II). In any event, for a given total number of observations, the digital assay will yield more reliable results when the concentrations of test and reference genes are at (operating point) or near (operating range) the values given in Table 1.

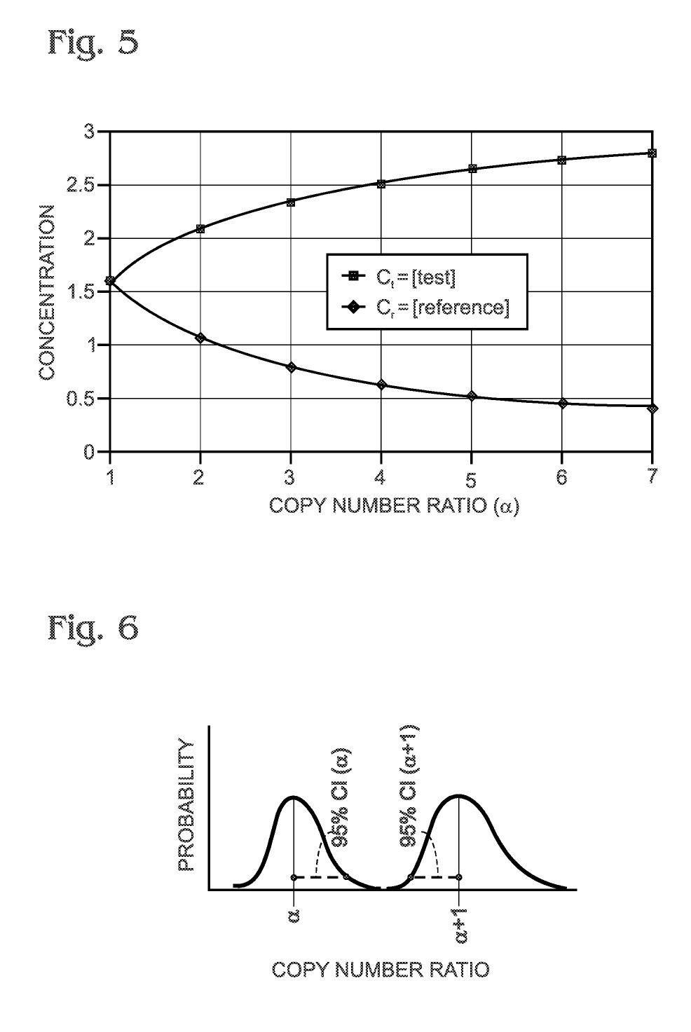

FIG. 4 shows a graphical representation of data from Table 1. A portion of the graph of FIG. 3 is reproduced here and is marked with dashed lines to identify pairs of optimal test and reference concentrations for the various copy number ratios indicated (also see Table 1). FIG. 5 show a graph plotting the optimal concentrations of FIG. 4 as a function of copy number ratio.

The system also may be used to determine confidence intervals for measured concentrations and derivative measures. For example, the 95% confidence interval for a measured concentration, c, is 2×1.96×σ_{c}=3.92σ_{c}.

The ability to determine confidence intervals also makes it possible to determine the conditions under which derivative measures such as adjacent CNV levels can be distinguished. Two adjacent CNV levels, α and α+1, can be distinguished provided their one-sided 95% confidence intervals do not overlap, assuming the distributions of α and α+1 are symmetrical. The discrimination condition is given by Equation (14):

F(α)=2*1.96*(σ_{α}+σ_{α+1})<1, σ_{α}=α*δ_{α} (14)

FIG. 6 shows a graph of the probability distributions for a sequential pair of copy number ratios (α and α+1), with the 95% confidence interval (“CI”) for each distribution shown with respect to the mean of the distribution.

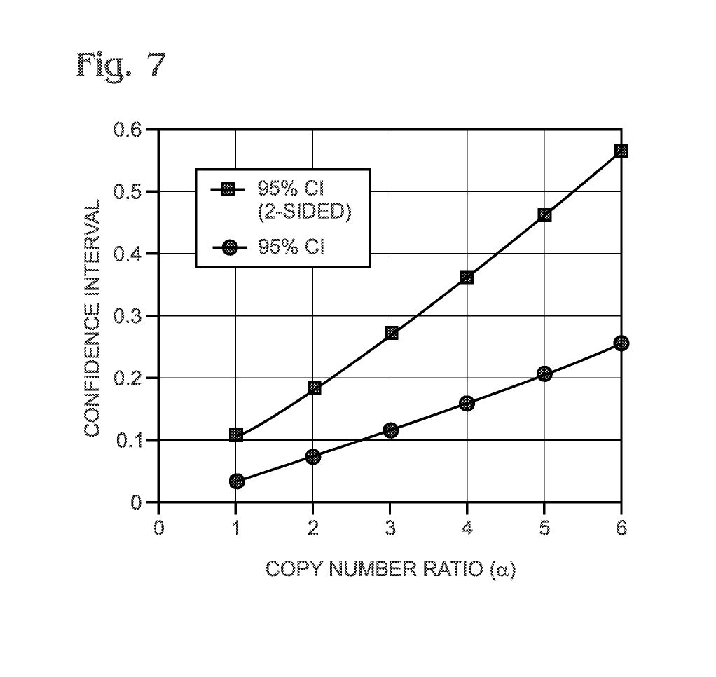

FIG. 7 shows a graph of 95% confidence intervals (one-sided and two-sided) as a function of copy number ratio, where N=10,000. The graph shows that N=10,000 allows reliable discrimination between values for a of five and six. The ability to discriminate scales as 1/\sqrt{N}. Accordingly, the number of droplets or other partitions used in a digital assay can be adjusted to achieve the desired confidence of discrimination.

### IV. Selected Embodiments

This section presents selected embodiments of the present disclosure related to digital assays with reduced measurement uncertainty. The selected embodiments are presented as a set of numbered paragraphs.

1. A method of performing a digital assay with reduced measurement uncertainty, the method comprising: (A) providing an expected value for a measure that is a function of a level of a first target and a level of a second target in a sample; (B) obtaining an optimal concentration for the first target based on the expected value; (C) forming partitions based on the optimal concentration obtained, wherein each partition includes a portion of the sample, and wherein only a subset of the partitions contain at least one copy of the first target and only a subset of the partitions contain at least one copy of the second target; (D) amplifying the first and second targets in the partitions; (E) collecting amplification data from the partitions; and (F) determining an experimental value for the measure based on the amplification data.

2. The method of paragraph 1, wherein the optimal concentration provides a minimized relative uncertainty of the measure in a digital assay.

3. The method of paragraph 2, wherein the minimized relative uncertainty is a function of a first relative uncertainty of a concentration of the first target and a second relative uncertainty of a concentration of the second target.

4. The method of paragraph 3, wherein the relative uncertainty for each target is a ratio of the standard deviation to the mean for concentration of the target.

5. The method any of paragraphs 1 to 4, wherein the experimental value is a first experimental value, further comprising a step of repeating the steps of providing, obtaining, forming, amplifying, and determining with the first experimental value as the expected value, such that a second experimental value is determined.

6. The method of any of paragraphs 1 to 5, wherein the measure corresponds to a ratio of the levels of the first and second targets.

7. The method of any of paragraphs 1 to 6, wherein the measure is a ratio of the level of the first target or second target to a sum of the levels of the first and second targets, or vice versa.

8. The method of any of paragraphs 1 to 5, wherein the measure represents a level of linkage or non-linkage of the first and second targets to one another.

9. The method of any of paragraphs 1 to 8, wherein the optimal concentration is obtained from a set of pre-computed optimal concentrations each associated with a different potential value or potential range of the measure.

10. The method of paragraph 9, wherein the step of obtaining includes a step of consulting a table containing the pre-computed optimal concentrations.

11. The method of paragraph 10, wherein the table is provided by a printed document or an electronic device.

12. The method of any of paragraphs 1 to 11, wherein the measure is a ratio, wherein the step of obtaining includes a step of comparing the expected value with a set of potential ratios, and wherein each potential ratio is associated with a pre-computed, optimal target concentration that minimizes measurement uncertainty for such potential ratio.

13. The method of paragraph 12, wherein the set of potential ratios includes a plurality of values, and wherein each of the plurality of values is an integer.

14. The method of any of paragraphs 1 to 13, wherein the step of obtaining includes a step of computing the optimal concentration based on the expected value after the expected value is provided.

15. The method of any of paragraphs 1 to 14, wherein the optimal concentration represents an average of less than about ten copies of the first target, the second target, or each target per partition.

16. The method of any of paragraphs 1 to 15, wherein the expected value is an integer or a half-integer.

17. The method of any of paragraphs 1 to 6 and 9 to 15, wherein the sample is provided by a subject, wherein the first target represents a reference template having a known copy number per haploid genome of the subject, and wherein the second target represents a test template have a copy number being tested with respect to the known copy number of the reference template.

18. The method of any of paragraphs 1 to 17, wherein the step of providing includes a step of performing a preliminary test to estimate the expected value.

19. The method of any of paragraphs 1 to 18, wherein the optimal concentration obtained is a single value or a range of values.

20. The method of any of paragraphs 1 to 19, wherein the partitions are droplets.

21. The method of any of paragraphs 1 to 20, wherein the measure is a ratio, and wherein the step of obtaining includes a step of selecting a preferred concentration for the first target based on the expected value and a table containing a set of potential values or ranges for the ratio, with each potential value or range being associated with an optimal target concentration for such potential value or range, and wherein the step of forming is based on the preferred concentration.

22. The method of paragraph 21, wherein the set of potential values or ranges includes a set of integer values.

23. The method of paragraph 21 or 22, wherein the optimal target concentration for each potential value or range is a single concentration value or a range of concentration values.

24. The method of any of paragraphs 21 to 23, wherein the ratio corresponds to a copy number ratio of the first target to the second target, or vice versa.

25. The method of any of paragraphs 21 to 24, wherein the preferred concentration represents an average of less than about ten copies of the first target, the second target, or each target per droplet.

26. The method of any of paragraphs 21 to 25, wherein the table is stored electronically.

27. The method of any of paragraphs 21 to 26, wherein the step of selecting is performed at least in part by a computer.

28. The method of any of paragraphs 21 to 26, wherein the table is provided by a printed document.

29. The method of any of paragraphs 21 to 28, wherein the potential values or ranges in the table are values including 1, 2, and 3.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

I claim:

1. A method of performing a digital assay with reduced measurement uncertainty, the method comprising:
providing an expected value for a measure that is a function of a level of a first target and a level of a second target in a sample;
obtaining an optimal concentration for the first target based on the expected value;
forming partitions based on the optimal concentration obtained, wherein each partition includes a portion of the sample, and wherein only a subset of the partitions contain at least one copy of the first target and only a subset of the partitions contain at least one copy of the second target;
amplifying the first and second targets in the partitions;
collecting amplification data from the partitions; and
determining an experimental value for the measure based on the amplification data.

2. The method of claim 1, wherein the measure corresponds to a ratio of the levels of the first and second targets.

3. The method of claim 1, wherein the measure corresponds to a ratio of the level of the first target or second target to a sum of the levels of the first and second targets, or vice versa.

4. The method of claim 1, wherein the measure represents a level of linkage or non-linkage of the first and second targets to one another.

5. The method of claim 1, wherein the optimal concentration is obtained from a set of pre-computed optimal concentrations each associated with a different potential value or potential range of the measure.

6. The method of claim 5, wherein the step of obtaining includes a step of consulting a table containing the pre-computed optimal concentrations.

7. The method of claim 6, wherein the table is provided by a printed document or an electronic device.

8. The method of claim 1, wherein the measure is a ratio, wherein the step of obtaining includes a step of comparing the expected value with a set of potential ratios, and wherein each potential ratio is associated with a pre-computed, optimal target concentration that minimizes measurement uncertainty for such potential ratio.

9. The method of claim 8, wherein the set of potential ratios includes a plurality of values, and wherein each of the plurality of values is an integer or half-integer.

10. The method of claim 1, wherein the step of obtaining includes a step of computing the optimal concentration based on the expected value after the expected value is provided.

11. The method of claim 1, wherein the expected value is an integer or a half-integer.

12. The method of claim 1, wherein the sample is provided by a subject, wherein the first target represents a reference template having a known copy number per haploid genome of the subject, and wherein the second target represents a test template have a copy number being tested with respect to the known copy number of the reference template.

13. The method of claim 1, wherein the optimal concentration obtained is a single value or a range of values.

14. The method of claim 1, wherein the partitions are droplets.

15. A method of performing a digital assay with reduced measurement uncertainty, the method comprising:
providing an expected value for a ratio involving a level of a first target and a level of a second target in a sample;
selecting a preferred concentration for the first target based on the expected value and a table containing a set of potential values or ranges for the ratio, with each potential value or range being associated with an optimal target concentration for such potential value or range;
forming droplets containing the first target according to the preferred concentration, wherein each droplet includes a portion of the sample, and wherein only a subset of the droplets contain at least one copy of the first target and only a subset of the droplets contain at least one copy of the second target;
amplifying the first and second targets in the droplets;
collecting amplification data from the droplets; and
determining an experimental value for the ratio based on the amplification data.

16. The method of claim 15, wherein the set of potential values or ranges includes a set of integer values.

17. The method of claim 15, wherein the optimal target concentration for each potential value or range is a single concentration value or a range of concentration values.

18. The method of claim 15, wherein the ratio is a copy number ratio of the first target to the second target, or vice versa.

19. The method of claim 15, wherein the table is provided by a printed document.

20. The method of claim 15, wherein the table is provided by an electronic device.
